(19) United States
(12) Patent Application Publication
(10) Pub. No.: US 2021/0124019 A1
(43) Pub. Date: Apr. 29, 2021

(54) LIDAR OPTICAL SYSTEM WITH FLAT OPTICS AND ROTATING MIRROR ENABLING 360-DEGREE FIELD-OF-VIEW AT HIGH FRAME RATE, HIGH SPATIAL RESOLUTION AND LOW POWER CONSUMPTION

(71) Applicant: Lookit.ai, San Jose, CA (US)

(72) Inventors: Jack Tsai, San Jose, CA (US); Rickmer E. Kose, San Francisco, CA (US); Ming Chou Lin, Singapore (SG); Daniel B. Oliver, San Jose, CA (US)

(21) Appl. No.: 17/077,987

(22) Filed: Oct. 22, 2020

Related U.S. Application Data
(60) Provisional application No. 62/937,582, filed on Nov. 19, 2019.
(60) Provisional application No. 62/937,577, filed on Nov. 19, 2019.
(60) Provisional application No. 62/931,652, filed on Nov. 6, 2019.
(60) Provisional application No. 62/928,750, filed on Oct. 31, 2019.
(60) Provisional application No. 62/925,537, filed on Oct. 24, 2019.

(51) Int. Cl. G01S 7/481; G01S 7/4863; G01S 17/894

(52) U.S. Cl. CPC G01S 7/4813; G01S 17/931; G01S 17/894; G01S 7/4863

(57) ABSTRACT

A 360-degree Field-Of-View LiDAR is capable of delivering light to a target and detecting a fraction of the light reflected from the target to determine the distance from the light source/detector to the target placed at any point of a 360-degree panoramic field of view across various vertical elevation angles depending on the azimuthal angles. The LiDAR implementation allows the built-in array laser light source and an array of detectors to be scanned across the entire azimuthal angular range. The LiDAR implementation has the unique arrangement of the array of laser light sources, and the array of detectors affixed to a rigid base while the rotating periscope scanner contains a motor and mirror which can rotate in-plane to project the light source to its surroundings and receive light from surroundings. The system delivers a high frame rate, a high spatial (VGA-like) resolution, and a low power consumption system.

### CROSS-REFERENCE TO RELATED APPLICATION(S)

This application claims priority under 35 U.S.C. § 119(e) of the U.S. Provisional Patent Application Ser. No. 62/937,582, filed Nov. 19, 2019 and titled, “Suspension Damper System for Vibration Control of Time of Flight System,” U.S. Provisional Patent Application Ser. No. 62/937,577, filed Nov. 19, 2019 and titled, “Closed Loop Temperature Controlled Time-Of-Flight System,” U.S. Provisional Patent Application Ser. No. 62/931,652, filed Nov. 6, 2019 and titled, “Flat Optics With Passive Elements Functioning As A Transformation Optics And A Compact Scanner To Cover The Vertical Elevation Field-Of-View,” U.S. Provisional Patent Application Ser. No. 62/928,750, filed Oct. 31, 2019 and titled, “LiDAR Optical System With Dual Capabilities Of Far-Field And Near-Field Object Detection And Ability To Vary The Vertical-Field Of-View Coverage,” U.S. Provisional Patent Application Ser. No. 62/925,537, filed Oct. 24, 2019 and titled, “LiDAR Optical System With Flat Optics And Rotating Mirror To Enable 360-degree Field-Of-View At High Rotational Speed And Low Current Draw,” which are all hereby incorporated by reference in their entireties for all purposes.

### FIELD OF THE INVENTION

The present invention relates to the optical delivery and optical receiving system in the field of Light Detection and Ranging (LiDAR).

### BACKGROUND OF THE INVENTION

In the existing LiDAR designs, the system is equipped with lasers and detectors that are located on a rotating spindle and is capable of performing 360-degree azimuthal Field Of View (FOV). As the spindle rotates, the lasers on the spindle are triggered by an external trigger and turned on momentarily to deliver light while aiming at targets a far distance away. Simultaneously, the detectors are turned on while waiting to receive the reflected light from the targets. In order to power the driving electronics of the active laser and detector elements and transmit digital signal data from the lasers and detectors, an external power supply electronic circuitry is used but can only be inductively coupled to boards through the spindle. One inherent shortcoming of the inductive couple design is that the active elements (laser array and detector array) which are mounted on a rotating spindle can experience intermittently open-circuit issues due to wear and tear on the slip rings which is an inherent part of the inductive charging circuitry. Such occurrences can prevent the LiDAR system from reliably providing the electrical current to the laser and detector elements as well as transmitting the digital signals to and from the laser and detector driver electronics through the inductive circuit of a rotating spindle. Previous LiDAR implementations also have a slow frame rate and poor image resolution in addition to the connection issues.

### SUMMARY OF THE INVENTION

The LiDAR optical system described herein addresses such shortcomings by placing the laser array and detector array on a stationary mount which allows a direct connection to the external power supply to drive the electronics and transmit the data from the board to the outside world at the same time still incorporating a unique set of optics to serve the purpose of scanning the surroundings with a 360-degree azimuthal Field of View (FOV) and high spatial vertical resolution. The periscope scanner design enables Video Graphics Array (VGA)-like spatial image resolution at a high frame rate. An important element of the LiDAR optical system emphasizes how the point clouds are formed differently from the previous design whereby the vertical lines from the reflected light can vary as a function of horizontal scanning angles.

### BRIEF DESCRIPTION OF THE DRAWINGS

FIG. 1 illustrates a front view of a cross section view of the inner construction of the LiDAR optical system according to some embodiments.

FIG. 2 illustrates a side view of a cross section view of the inner construction of the LiDAR optical system according to some embodiments.

FIG. 3 illustrates a side view of a cross section view of the LiDAR optical system according to some embodiments.

FIG. 4 illustrates a view of the inner construction of the LiDAR showing the axial field motor and the rotating mirror according to some embodiments.

FIG. 5 illustrates the change in vertical elevation of a single emitter, 2×2 emitter array, 4×4 emitter array as function of azimuthal angle rotation according to some embodiments.

FIG. 6 illustrates the elliptical path that emitter traverses as the deflecting mirror rotates about its vertical axis according to some embodiments.

FIG. 7 illustrates the starting elevation angle gradually rotating in its vertical position as the periscope rotates about the vertical axis according to some embodiments.

FIG. 8 illustrates how the array of emitters on the target undergoes rotation as the motor rotates according to some embodiments.

FIG. 9 illustrates an exemplary 2×5 VCSEL array with 10 VCSEL dies according to some embodiments.

FIG. 10 illustrates an exemplary 1×16 SPAD detector array with 16 APD elements according to some embodiments.

FIG. 11 illustrates the placement of flat optics relative to the VCSEL array and how light is more collimated by the flat optics according to some embodiments.

FIG. 12 illustrates the working principles of collimating flat optics and its ability to reduce the beam divergence from the emitter according to some embodiments.

FIGS. 13 and 14 illustrate a flat optics-based focusing lens that can focus the reflected light from the target into individual detector elements according to some embodiments.

FIG. 15 illustrates the electronics for controlling the LiDAR optical system according to some embodiments.

FIG. 16 illustrates a combination of a rotating mirror and the deflecting flat optics can operate similarly to Risley Prisms which can steer the laser beam to a given vertical elevation according to some embodiments.

FIG. 17 illustrates metasurface/flat optics which can passively steer the laser beam to a given vertical elevation according to some embodiments.

FIG. 18 illustrates ray tracing of the LiDAR optical system indicating how the laser source is reflected off the target and then is collected by the detector according to some embodiments.

FIG. 19 illustrates an optical system with Risley Scanner design according to some embodiments.

FIG. 20 illustrates the angular resolution of the image which is also defined as spatial resolution according to some embodiments.

FIG. 21 illustrates a diagram of a damper ring with springs and screws according to some embodiments.

FIG. 22 illustrates a diagram of a metasurface/flat optics implementation according to some embodiments.

FIG. 23 illustrates a diagram of a meta-atom deflection configuration according to some embodiments.

FIGS. 24A-B illustrate diagrams and analysis of deflection by an aperiodic meta-atoms structure according to some embodiments.

FIG. 25 illustrates a diagram of a deflector metasurface at 0.5 degrees according to some embodiments.

FIG. 26 illustrates diagrams of vertical and horizontal deflector metasurfaces according to some embodiments.

FIG. 27 illustrates the change in vertical elevation of an 8×8 emitter array as function of azimuthal angle rotation according to some embodiments.

FIG. 28 illustrates a diagram of a coaxial configuration according to some embodiments.

FIG. 29 illustrates the periscope mirror rotating in conjunction with the deflector/metasurface optics according to some embodiments.

### DETAILED DESCRIPTION OF THE PREFERRED EMBODIMENT

A Time-Of-Flight (TOF) optical system (also referred to as a LiDAR optical system) is designed to measure the total time it takes for a photon to travel to a target at some distance away and for the reflected photon to travel back from the target to the detector. Depending on how much time it takes for a photon from the laser to hit the target and the reflected photons to be detected by the detector, the total travel distance can be determined. The LiDAR optical system as disclosed herein differs from previous implementations in how a 360-degree azimuthal FOV is achieved, and how high vertical spatial resolution at a high frame rate is achieved. Each light path is launched independently and scans a different location in space, and then the detectors detect a light source coming from each different location in space simultaneously which allows the periscope mirror to spin very fast compared to previous implementations. For example, the frame rate is able to be 60 Hz or greater. The LiDAR optical system is able to have lasers or a laser array and detectors or a detector array stationarily mounted on a rigid base but at the same time scan the full 360-degree surroundings via a rotating mirror. In some embodiments, the lasers or a laser array and detectors or a detector array have a coaxial orientation In the LiDAR optical system, the light from the laser array is directed to the outside world using a rotating periscope, thus enabling a 360-degree horizontal FOV.

FIG. 1 illustrates a front view of a cross section view of the inner construction of the LiDAR optical system according to some embodiments. As seen from this view, the LiDAR optical system includes: a transparent cover lid 100, a periscope bracket with mirror 102, a top rotor back plate 104, a flat optics lens 106, a Vertical-Cavity-Surface-Emitting Laser (VCSEL) illuminator plate assembly 124, a collimator lens (e.g., flat optics) 128, a thin section bearing 140, and a 12-pole axial magnet 144. Additional components are able to be seen in other views of the LiDAR optical system. In some embodiments, fewer or additional components are included in the LiDAR optical system. In some embodiments, variations of components are included in the LiDAR optical system.

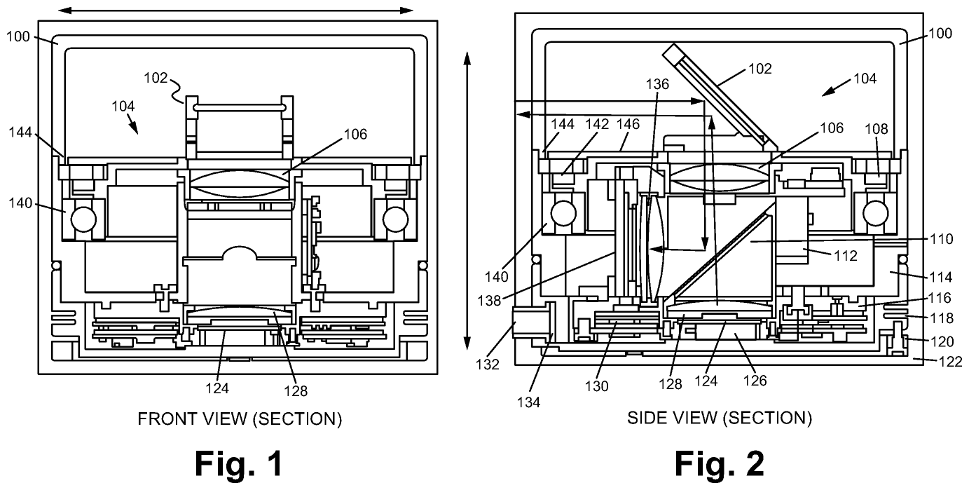

FIG. 2 illustrates a side view of a cross section view of the inner construction of the LiDAR optical system according to some embodiments. The LiDAR optical system includes: a transparent cover lid 100, a periscope bracket with mirror 102, a top rotor back plate 104, a flat optics lens 106, a rotor deck 108, a beam splitter with a holder bracket 110, a chemical absorbent 112, a housing 114, an optical bench 116, a heat sink 118, 3x springs with screws 120, a damper ring block 122, a VCSEL illuminator plate assembly 124, a ThermoElectric Cooler (TEC) (with thermal grease) 126, a collimator lens (e.g., flat optics) 128, dual stack PCBAs with foam interleave 130, an external outlet for data and power 132, an O-ring 134, a compound lens set assembly (e.g., flat optics) 136, a Single-Photon Avalanche Detector (SPAD) board assembly 138, a thin section bearing 140, a spacer ring 142, a 12-pole axial magnet 144, and a 9-coil stator bobbin 146. In some embodiments, fewer or additional components are included in the LiDAR optical system.

The side view of the LiDAR optical system shows the laser beam being emitted from the VCSEL illuminator plate assembly 124 through the beam splitter 110 to the periscope mirror 102 toward an object which reflects the beam (or part of the beam back to the periscope mirror 102 through the beam splitter 110 which directs the returning beam to the compound lens set assembly 136.

The configuration of the LiDAR optical system described herein eliminates the need to have the lasers and detector be co-located on a rotating spindle. The returned light from the target is intercepted by the periscope mirror 102 and guided into the detector array through the beam splitter 110 and focusing lens 136. The described configuration improves the overall electrical signal integrity because instead of inductive coupling as in the previous implementation, there is a physical connection that connects the signal lines and power supply lines of both emitters and detectors to the external world.

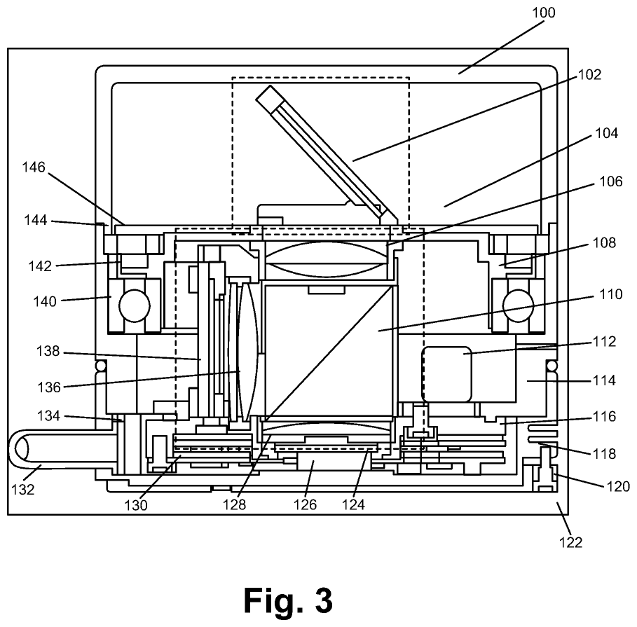

FIG. 3 illustrates a side view of a cross section view of the LiDAR optical system according to some embodiments. Aspects of the LiDAR optical system include a VCSEL array 124 as the light-emitting source, a Single-Photon Avalanche Detector (SPAD) array 138 as the light detection array, optical collimation lens (flat optics) elements 140 to collimate the exit laser beam from the VCSEL array 124, optical focusing lens (flat optics) elements 146 to focus the returned laser beam to the SPAD array 138, an optical beam splitter 110 that guides both the outgoing laser emitter beam path from the VCSEL array 124 to the rotating periscope mirror 102 out to the target as well as the reflecting the laser beam returning from the target back to the photodetector array 138, deflecting optical lens (flat optics) elements 106 along the optical path in between the beam splitter 110 and the periscope mirror 102 as part of the light delivery system where the purpose is to deflect the collimated laser light to a specific vertical elevation angle before the light goes to a reflecting mirror 102 on an axial field motor (similar to a periscope of a submarine), a cooling system (of the L beam), a vibration reduction system and a moisture/humidity mitigation system. In some embodiments, fewer or additional components are included in the LiDAR optical system.

In addition, the LiDAR optical system allows a dense emitter array and a detector array to be compactly integrated into the TOF system and is capable of achieving a VGA-like vertical and horizontal spatial resolution image. For example, the resolution is able to be 640×480 pixels or higher. A variable image resolution in vertical and horizontal directions is able to be acquired including a first set of resolution at low elevation angles and a second set of resolution at higher elevation angles. Similarly, in the horizontal direction, the firing duty cycle is able to be modified to increase the firing frequency or decrease the firing frequency. Each emitter within the laser array or group of emitters can be aligned to a corresponding detector element within the detector array. For the arrangement of the emitter with the corresponding detector, there can be one emitter to one detector, one emitter to many detector elements, many emitter elements to one detector element, and many emitters to many detector elements in terms of optical alignment in the vertical elevation direction. The emitter(s) from the pair are designed to point to a predefined vertical elevation angle while the detector(s) are set to receive light reflected back from the target of the same vertical elevation angle. Each matching pair can be steered by the deflecting lens flat optics to a specific vertical elevation angle as indicated in FIG. 3. Each emitter/detector pair for a given vertical elevation angle can undergo changes in the vertical elevation angle as the periscope rotates around its horizontal scanning angle to cover the entire 360° azimuthal angles.

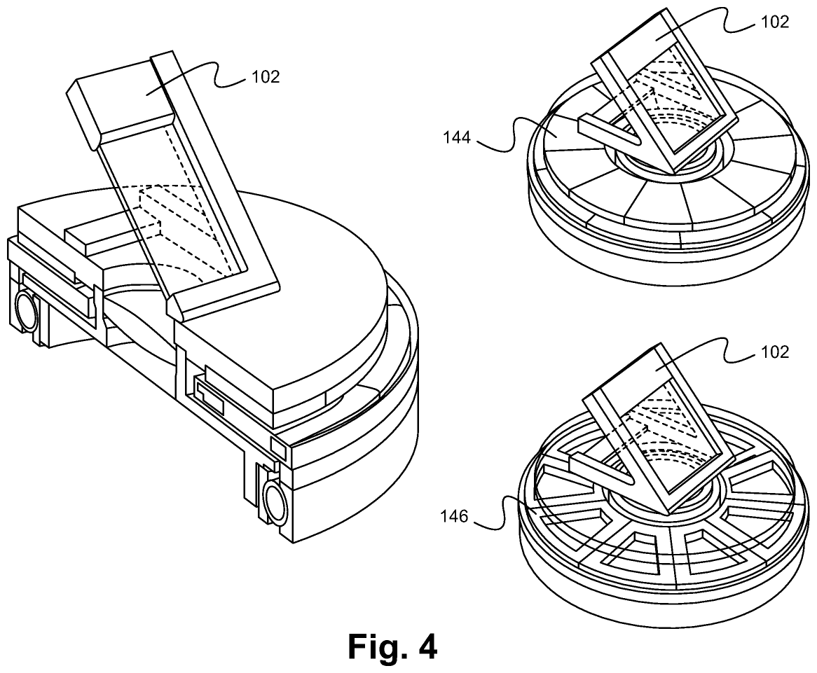

FIG. 4 illustrates the inner construction of the LiDAR showing the axial field motor and the rotating mirror. Specifically, the periscope mirror 102 is able to be moved using the motor magnetic ring 144 and the motor stator bobbin assembly 146. Another bearing is able to be added to limit the thrust effect if the LiDAR is mounted upside down.

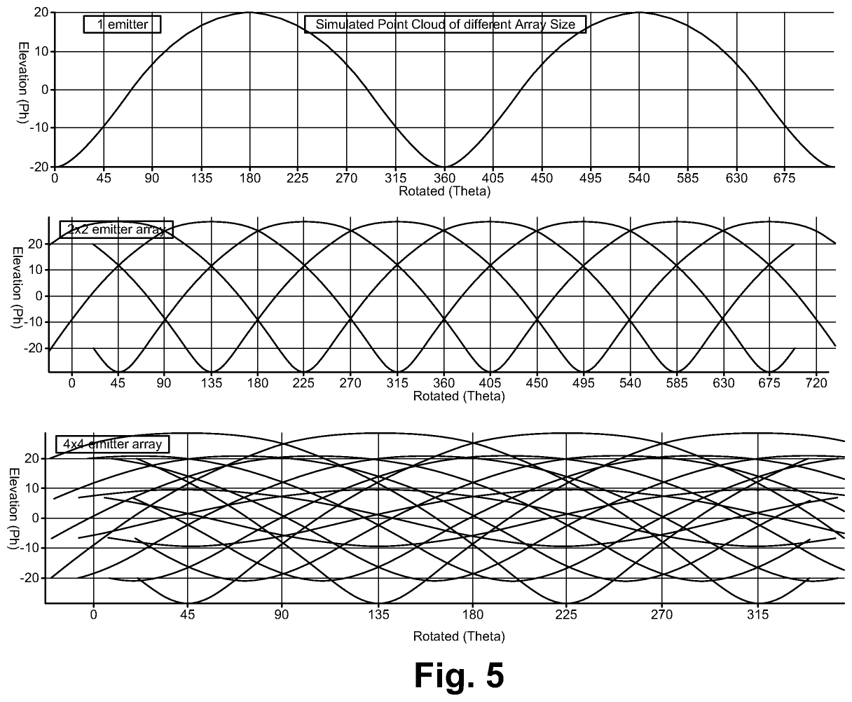

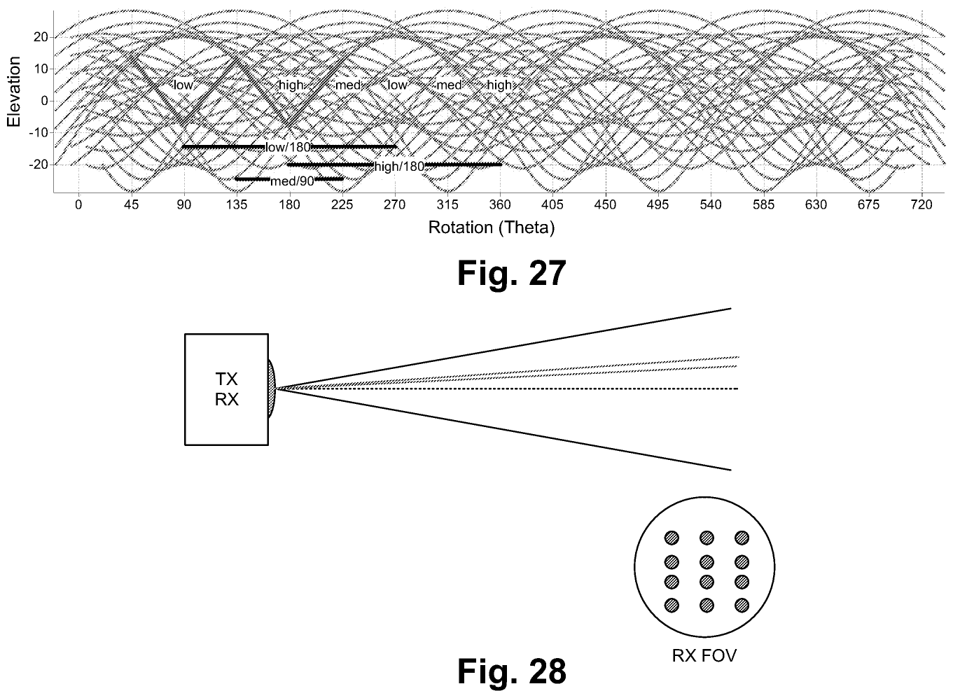

As shown in FIG. 5, the starting vertical elevation from a given emitter undergoes changes in the vertical elevation angle as the motor rotates from 0 degrees to 360 degrees in the azimuthal angles. FIG. 5 also shows the scanning vertical pattern for 1 emitter, a 2×2 emitter array and a 4×4 emitter array as a function of horizontal angles. Although 1, 2×2 and 4×4 emitter arrays are discussed, an 8×8 emitter array (FIG. 27), a 16×16 emitter array and beyond are able to be utilized. The changes in the vertical elevation angle as the periscope rotates occur due to the fact that each emitter/detector pair of particular elevation angle traverses an elliptical path as shown FIG. 5. Each elliptical path as the motor rotates is different for an emitter with a different starting vertical elevation angle, and the path repeats itself after a full 360° horizontal rotation.

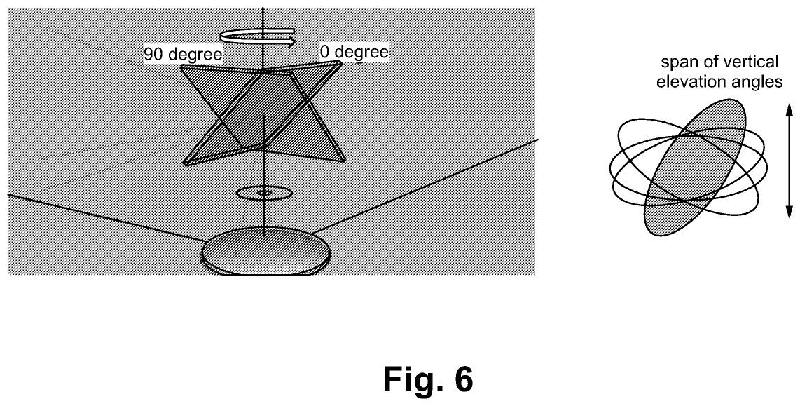

FIG. 6 illustrates the elliptical path that emitter traverses as the deflecting mirror rotates about its vertical axis according to some embodiments. Any given emitter of a fixed position will change the elevation angle as the mirror rotates. As the detecting mirror rotates about its vertical axis, the deflected light traverses an elliptical path.

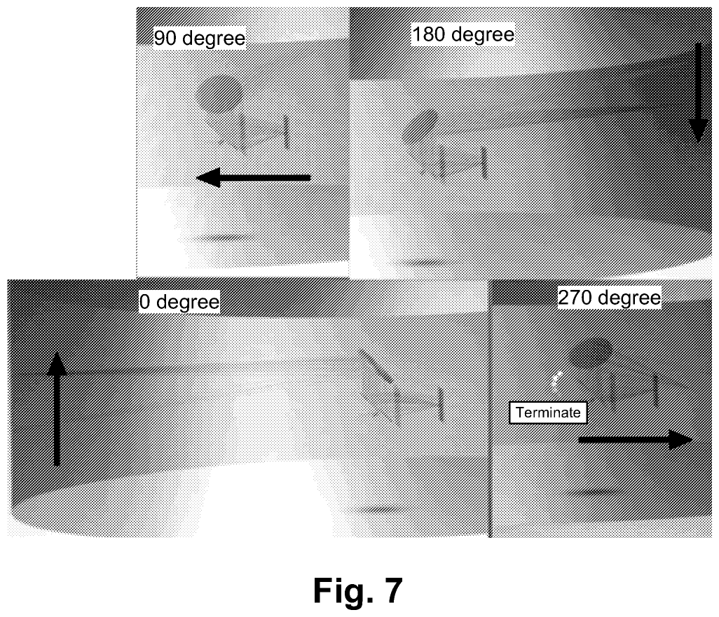

FIG. 7 illustrates the starting elevation angle will gradually rotate in its vertical position as the periscope rotates about the vertical axis according to some embodiments. The disk shown is the deflecting mirror which rotates the emitting light source 90 degrees normal to original angle.

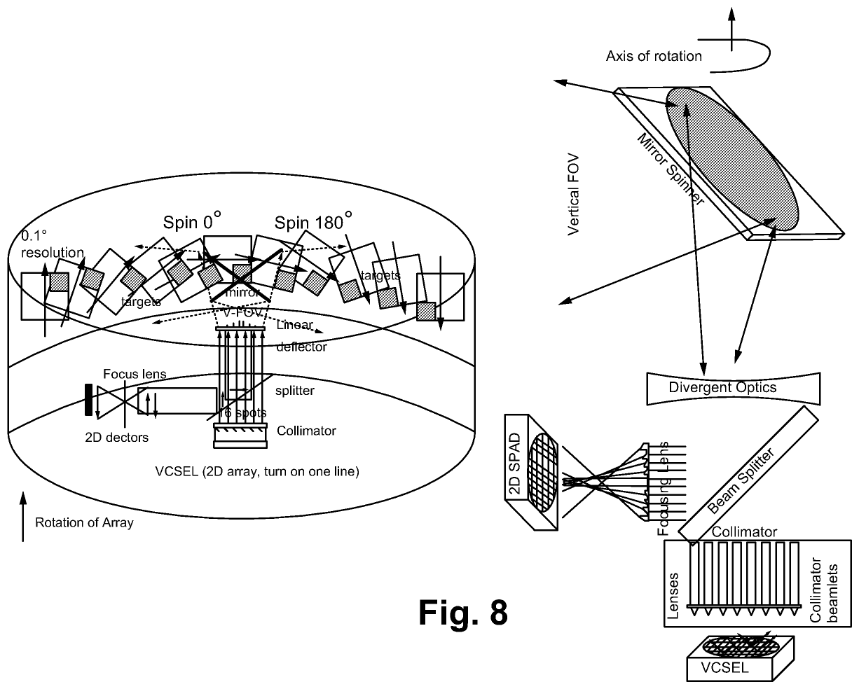

FIG. 8 illustrates how the array of emitters on the target will undergo rotation as the motor rotates according to some embodiments. The square represents the image of an array on the target. As the mirror rotates, the frame of reference rotates. When the frame of reference rotates, it allows the fixed line to scan a different spatial geometric coordinate in the space. By rotating, much higher resolution content is able to be acquired.

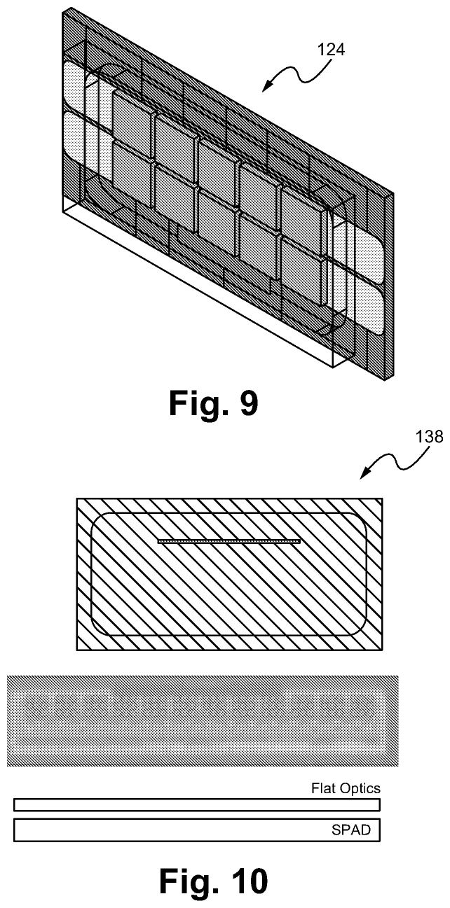

FIG. 9 illustrates the configuration of an exemplary VCSEL array light source according to some embodiments. The VCSEL 124 includes multiple dies and multiple emitter elements to form an array. Each light-emitting element within the die can either be individually selected or emit all at the same time depending on the electronic driver's configuration. On top of the emitter element or die, there is a collimating optical element (“flat optics”) to collimate the emitted laser beam and therefore reduces the laser beam divergence. The VCSEL shown is an example, and any other VCSEL (or other device) is able to be utilized.

FIG. 10 illustrates one of the configurations of an exemplary SPAD array according to some embodiments. The SPAD array 138 is comprised of multiple Avalanche Photo Diode (APD) elements that can be individually selected. Individual detector elements on the SPAD array 138 are aligned to receive incoming reflected light corresponding to a particular illuminated portion of the target by the emitter of a specific vertical elevation angle. The SPAD shown is an example, and any other SPAD (or other device) is able to be utilized.

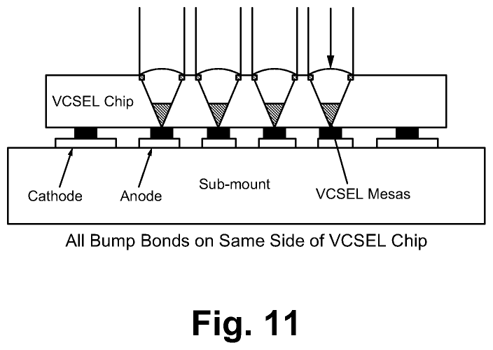

It is important that multiple beamlets from the VCSEL array together with the flat optics are collimated uniquely to cover the full area of the deflecting lens as shown in FIG. 11. After the collimation, the light traverses to the beamsplitter before the light arrives at the deflecting lens which deflects the collimated beam to a specific range of vertical elevation angles and is also defined as Vertical Field-of-View (V-FOV).

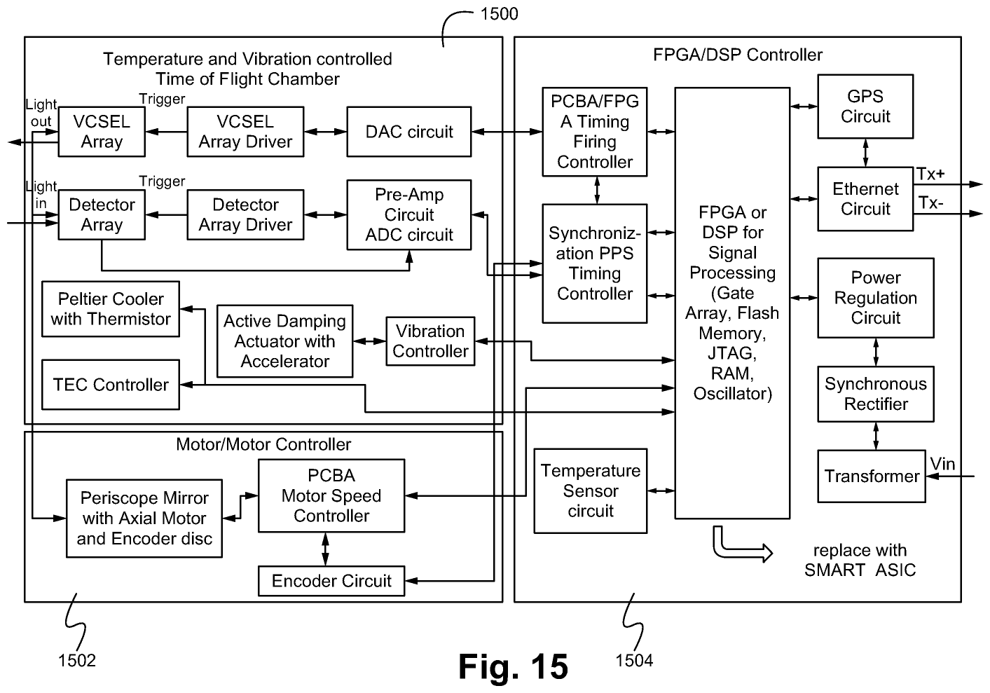

For the vertical spatial resolution of the LiDAR optical system, it is determined by how emitter/detector pairs that are uniquely aligned in a predefined spacing and point to a particular vertical elevation as shown in FIG. 8. For the purpose of illustration, as shown in FIG. 20, it can be understood that the smaller the angular spacing between adjacent pairs, the higher the spatial resolution (ability to resolve the separation between two nearest objects). Similarly, for horizontal spatial resolution, it is determined by the pulse width of the laser, the repetition rate or duty cycle of laser pulses, and the rotational speed of the periscope. The faster the repetition of the laser and the higher rotational speed of the periscope, the higher the horizontal spatial resolution is. For a given channel of the LiDAR, it is defined by the unique individual emitter(s) and detector(s) pair and has a specific vertical angular position. The total number of channels in the LiDAR corresponds to the total number of the emitter and detector pairs, and together they cover a specific range of vertical elevation angles. Switching on/off of the pair is accomplished with the controlling electronics which simultaneously trigger the laser firing and turn on the detector. The electronics of the LiDAR optical system provide the controls and synchronization of the sequence of the laser firing and the detector receiving light to ultimately measure the time for the photon to traverse from the laser source to the target and back from the target to the detector (as shown in FIG. 15). The VCSEL, SPAD, and triggering electronics are important aspects of the LiDAR optical system.

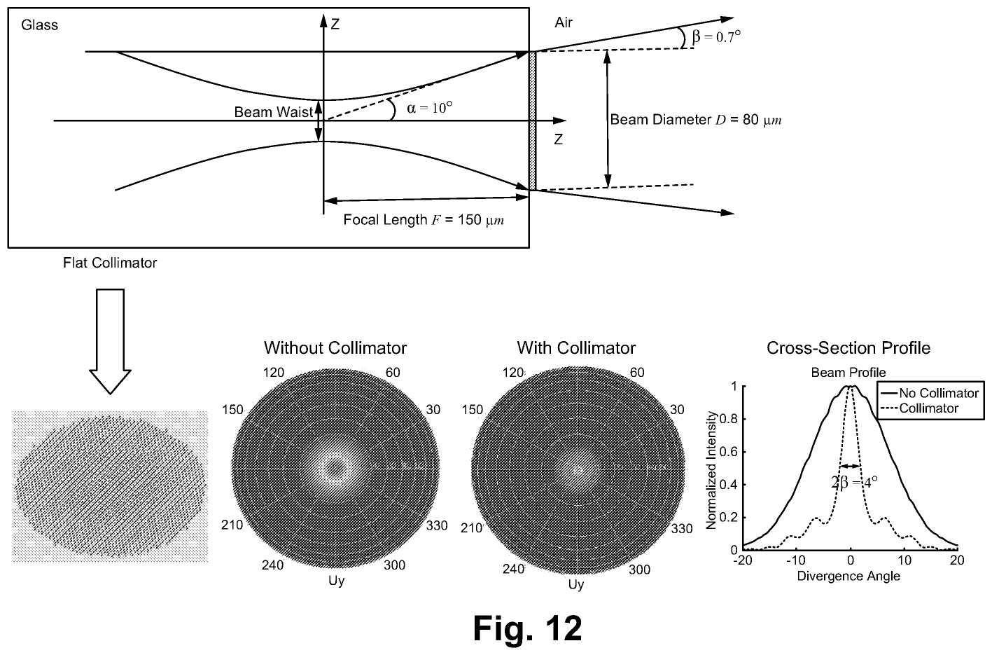

In order to get the outgoing beam from VCSEL to be properly collimated, there is a collimating lens in front of the VCSEL. After the laser beam from each emitter is steered by the microlens, there is a collimation lens array which is metasurface based flat optics comprising an array of sub-micron pillars which are able to collectively bend light to a specific angle. The metasurface optics has a certain focal length akin to a conventional optical lens and serves the purpose of reducing the divergence of the beam from each emitter of VCSEL array, as shown in FIG. 12. Similarly, in order to properly focus the reflected return beam into the detector, there is a focusing lens in front of the SPAD as shown in FIG. 10 and each pair can be uniquely collimated and selected. Finally, the construction of the point cloud in the TOF system is based on an aggregation of all the data points by all the channels which cover various vertical elevation angles for three-dimensional sensing.

The LiDAR optical system can deliver laser light from fixed-mount emitters to its intended targets and collect the reflected light from the target back to the detectors at a fixed location while the periscope rotates to cover the entire 360 azimuthal angles. For the lasers and detectors to remain stationary throughout the entire 360-degree azimuthal FOV by only rotating the periscope mirror, the system includes a beam splitter, a metasurface/flat optics element and a rotating periscope mirror as shown in FIG. 3. When the periscope rotates to cover different azimuthal angular positions, the outgoing light from the laser source can be reoriented as the light passes through a metasurface flat optics lens before the light goes to the reflecting periscope mirror. Similarly, the returned light after it passes through the periscope can be reoriented by the same metasurface/flat optics before the light goes through the beamsplitter and the focusing lens to guide the light into the detector element. FIG. 3 and FIG. 4 show the locations of the metasurface flat optics (Focusing Lens, Collimating Lens, and Deflecting Lens) in the configuration of the LiDAR. The three metasurface flat optics can work to steer the light source and reorient it to a different vertical elevation angle as the periscope mirror rotates. Similarly, the incoming reflected light from the target after exiting the rotating mirror can be re-oriented from the rotated frame of reference upon passing through the deflecting lens.

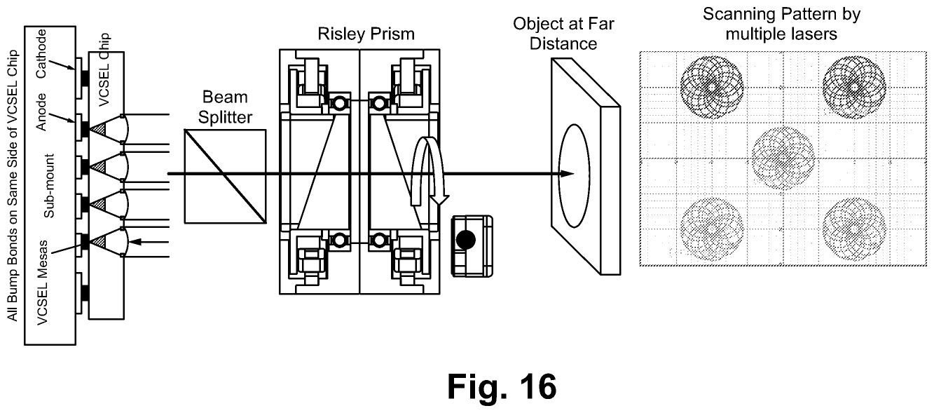

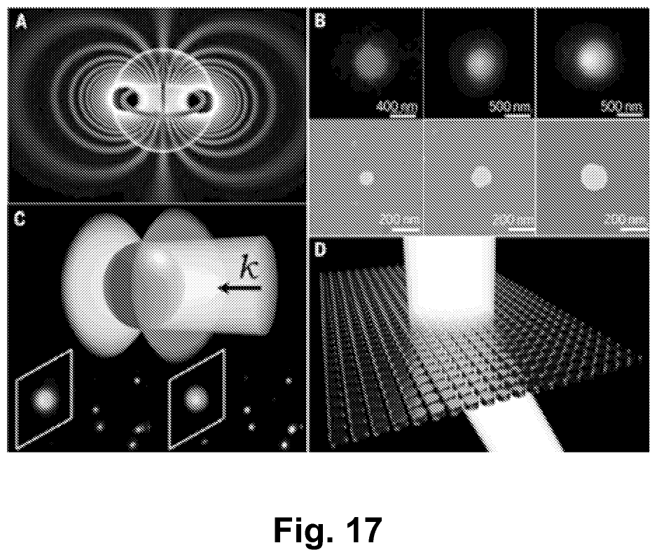

The combination of the deflecting flat optic with periscope mirror operates similarly to the operating principle of Risley Prism scanner which includes two wedge lens elements that can rotate independently with respect to one another. In the case of the Risley Prism, the wedge elements independently rotating can steer the light source to a certain vertical elevation as shown in FIG. 16. Similarly, a metasurface/flat optics is made of multiple geometric thin-film lens elements that are deposited on a transparent substrate, and the individual lens elements can passively steer the incoming beam or outgoing beam to its position as shown in FIG. 17. The advantage of the metasurface/flat optics is the fact that the optical element is fixed, and there is no mechanical movement required.

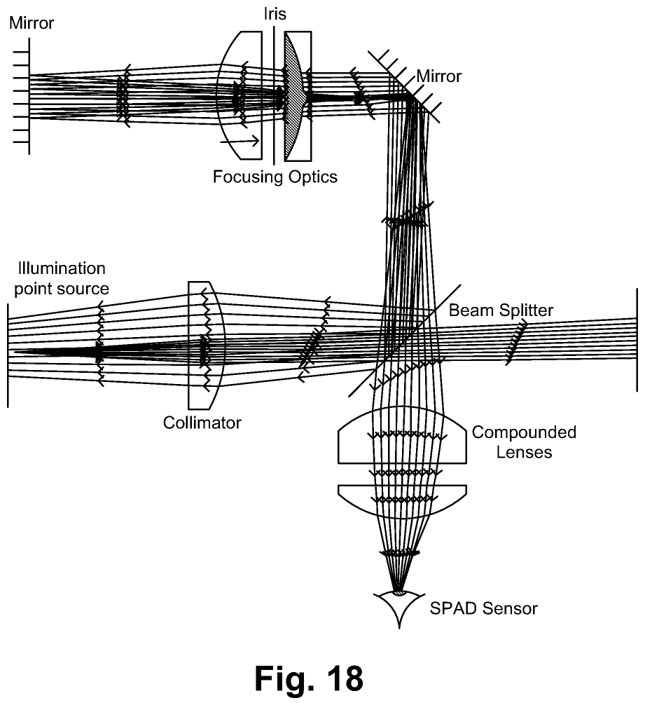

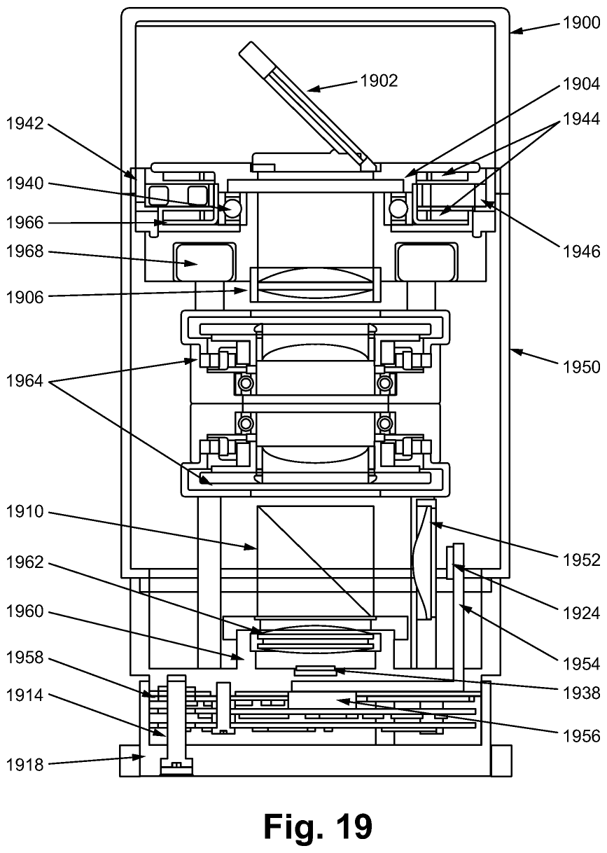

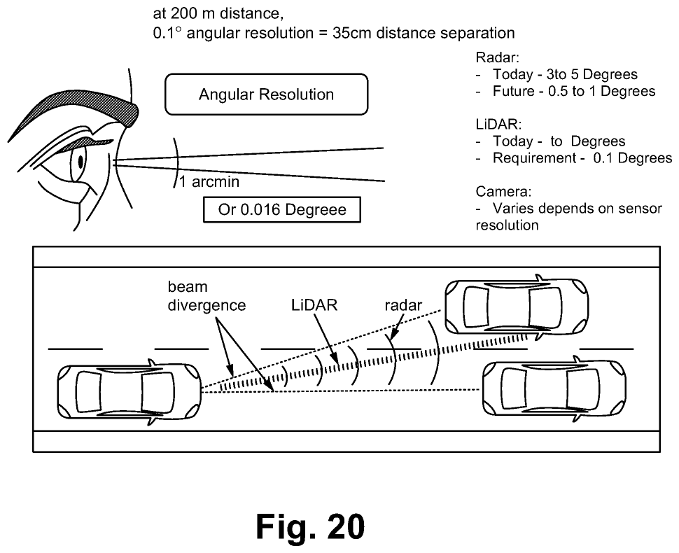

FIG. 18, shows the overall optical ray tracing paths of outgoing light from the laser source through all the optical elements in the system to the intended target and the return light path reflected from the target and back through the optical elements to the detectors. Finally, the overall height dimension of the LiDAR can become more compact by the use of flat optics and periscope mirror instead of Risley Prisms shown in FIG. 19.

The optical elements for the LiDAR optical system include: the VCSEL as the light source, SPAD as the detectors, collimation lens, focusing lens, beam splitter, deflecting lens, rotating mirror scanner, and the electronics that control the active devices. The configuration shows the integration of the VCSEL and SPAD array into the LiDAR whereby the VCSEL functions as a light emitter source, and the SPAD functions as the light detector. In some embodiments, VCSEL and SPAD arrays are tuned to near IR 940 nm wavelength. However, in some embodiments, other wavelengths of light are able to be accommodated. The arrangement of emitters on the VCSEL array and detectors on the SPAD array is important because they are constructed to be densely packed and aligned to a particular set of angular positions in order to achieve the desired spatial resolution and FOV. In some embodiments, the emitter and the detector element can be steered by the flat optics element which is situated in front of the active element, and the flat optics are fabricated separately and then packaged as part of the VCSEL and SPAD devices (refer to FIGS. 10 and 11 for the integration of the flat optics with the VCSEL and SPAD devices). In some embodiments, VCSEL and SPAD configurations are able to be accommodated as long as the input driver and the output signal line are compatible with the driving circuitry.

FIG. 19 illustrates an optical system with Risley Scanner design according to some embodiments. The LiDAR optical system includes: a transparent cover lid 1900, a periscope bracket with mirror 1902, a top rotor 1904, dual axial ring magnets 1944, an axial coil bobbin assembly 1946, a half-exterior casing 1950, a collimator 1952, a VCSEL illuminator source 1924, an L-plate 1954, a SPAD array sensor unit 1938, a thermoelectric cooler unit 1956, a base housing with a heat sink 1918, a base housing screw with a spring 1914, 3-tier PCBAs 1958, a optical bench 1960, a compounded lens subassembly 1962, a cube beam splitter subassembly 1910, a Risley prism subsystem 1964, a focusing lens subassembly 1906, a desiccant filter 1968, a bottom rotor 1966, a bearing 1940 and a stator spacer 1942. In some embodiments, fewer or additional components are included in the LiDAR optical system. In some embodiments, instead of utilizing flat optics a Risley prism subsystem is implemented.

In some embodiments, to achieve high spatial resolution, the light source from the emitters steered by the flat optics array, first undergoes collimation in order to reduce or eliminate the divergence of the beam as shown in FIG. 12. The outgoing path of the laser light after the beam collimation subsequently enters the flat optics deflecting element to steer the beam to a prescribed vertical elevation angle and covering a range of vertical field of view. In order to achieve high image spatial resolution, the motor rotates at a relatively high speed (60 Hz to 75 Hz). The speed of the motor is controlled by an optical encoder mounted at the bottom surface of the axial field motor as shown in FIGS. 1, 2 and 3. The ultra-compact axial field motor with a hollow core is an important part of the integrated system because the design allows minimal usage of space for the periscope. The vertical scanner performs two functions: (1) scans the vertical elevation range and (2) transforms from cartesian coordinates to polar coordinates.

After the light from the VCSEL passes through the collimator lens, it enters the rotating periscope mirror, which can then scan the entire 360 azimuthal angular range. The hollow core motor rotates the periscope mirror which comprises of axial field pancake-like stators and permanent magnets. When the stator is energized, it exerts an in-plane force on the permanent magnets which then rotates the mirror around the axis of rotation as shown in FIG. 4. A set of flat optics/metasurface as shown in FIG. 2 can replace the Risley Prism and perform the same scanning functions as the Risley Prisms. In such a scenario, the flat optics are made of sub-micron size geometric elements deposited on a transparent glass. As the light passes through the flat optics, the light can be passively steered in a similar fashion (as shown in FIGS. 16 and 17).

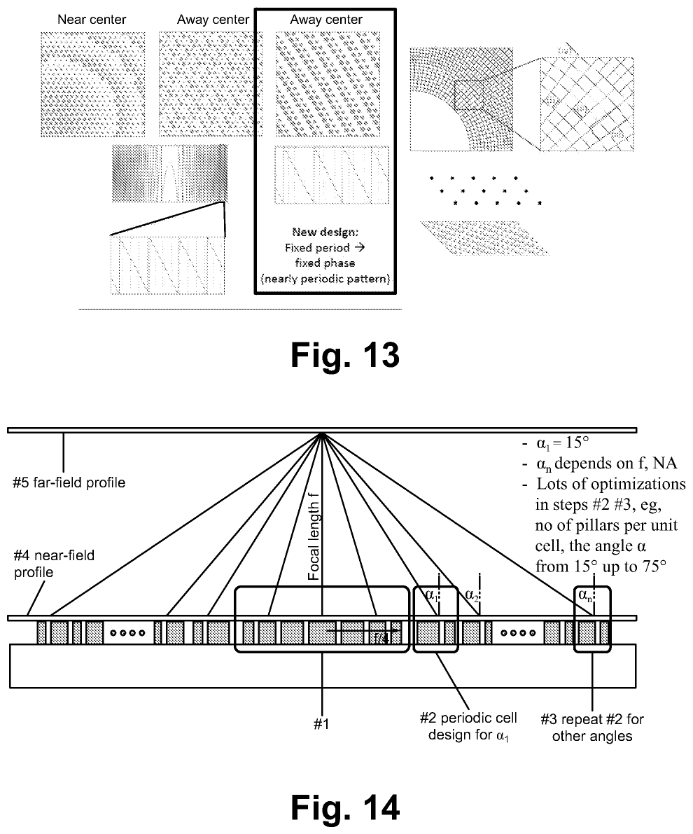

Similar to the VCSEL optical arrangement, there is a focusing lens flat optics element that is placed in front of the SPAD array to focus the light onto the individual detector element as shown in FIGS. 13 and 14. The return beam from the target will enter the periscope and from the periscope go to the focusing flat optics. For the returned beam, the flat optics can steer the beam onto the corresponding detector and transform the image in the Polar coordinates back to Cartesian coordinates.

In order to synchronize the laser firing and return light to the detector for the purpose of range determination, there is a set of electronics to coordinate the sequence of triggering and switching as represented by the block diagram in FIG. 15. The electronics also control the motor rotation 1502 and how the motor is in sync with the laser firing and detection of the returned light. The digital trigger activates the laser driver to fire the laser pulse, and at the same time turns on the detector window to detect the return light from the target. The amount of time elapsed before the detector detects the returned light from the target is used to determine the distance between the target and the sensor since the speed of light is a known constant. The converted distance value can then be determined by the FPGA 1504 and communicate to the outside world. In addition, the amplitude of the analog return signal which signifies the reflectance of the target can then be converted to digital counts, and the FPGA 1504 processes the amplitude/digital counts to report the relative reflectance of the target. Together for any given targeted point in space, there can be the spatial coordinates of the point, the time it takes to travel to the target and back, and the reflectance of the target. The 3D point cloud is therefore formed by aggregating all the points and representing them in a 3D format. A temperature and vibration controlled ToF chamber 1500 includes several aspects of the system.

To generate a dense point cloud of distance and reflectivity measurement points, both emitter and detector active elements are turning on/off at high repetition (typical repetition rate of 300 k to 1 million measurement points per second), which can result in excess heat generated. In order to mitigate the rising temperature in the TOF system, an active cooling system (also referred to or including a thermal conducting plate or a heat sink 118 in FIG. 3) is incorporated to remove the excess heat. Both the emitters and the detectors are mounted on a fixed location, which allows an easy access to the heat source. An active cooling system comprises a Peltier cooler, a thermal conducting plate, cooling fins, and a thermistor.

The VCSEL and SPAD elements are able to be mounted on the thermal conducting plate (FIG. 3). The thermal conducting plate is an L-shaped bracket with VCSEL mounted on the horizontal side of the bracket and the SPAD array mounted on the vertical side of the bracket. The thermal conducting plate is made of copper material (or another material with similar qualities) and can conduct heat from the heat source (VCSEL and SPAD) to the refrigeration side of the Peltier cooler. Afterwards, the Peltier cooler is attached to the backside of the bracket. The thermoelectric cooler (Peltier semiconductor cooler) can sink the heat away from the copper plate due to the temperature differential between the copper plate and the cold surface of the Peltier cooler. The electrical wiring of the Peltier cooler is connected to the controlling electronics, which is located at the bottom of the LiDAR housing. A Peltier cooler is a semiconductor, which operates based on the thermoelectric effect. The device has two sides, and when a DC electric current flows through the device, it brings heat from one side to the other, so that one side gets cooler while the other gets hotter. The “hot” side is attached to a heat sink so that it remains at ambient temperature, while the cool side goes below room temperature. After the Peltier cooler, there are slotted cooling fins on the outer body of the housing, which can remove the heat away from the refrigeration unit by a convection cooling mechanism. The backside of the Peltier cooler is mounted on top of the bottom housing of the LiDAR. The cooling fins (shown in FIG. 3), which are part of the bottom housing can face the outside such that the heat can be drawn away from the incoming cool air.

In order to have a closed loop cooling/refrigeration feedback, there is a thermistor located near the heat source to dynamically monitor the temperature of the LiDAR optical system. The overall hardware is controlled by a set of electronics, which is configured to receive the temperature readings of the LiDAR optical system from the thermistor and then dynamically activates the thermoelectric cooling system to remove the excess heat from the L-shaped bracket. With the closed loop feedback system, the overall LiDAR optical system can maintain a steady temperature environment during its operation. In some embodiments, the Peltier cooler is capable of removing ˜30 W of heat for a 40 mm×40 mm dimension. Since the average power consumption of the illumination and detectors are on the order 2 W, it is well within the capability of an off-the-shelf Peltier Cooler. Given the cooling mechanism is through conduction cooling by using a thermal conductive plate, there should be a minimum thermal disturbance to the surrounding air. The configuration described herein is just one of many different arrangements to achieve maximum heat dissipation. Another consideration is to have the PCBA mounted on the outside of the TOF camber to allow direct contact of the cooling fins with the optical bench. In the alternative configuration, it is possible to maintain a constant ambient temperature. Finally, the overall LiDAR optical system can remain very compact in footprint because the thermoelectric cooling system takes up a very minimal space.

For automotive applications, a great deal of accuracy and precision in the distance measurement is very important. One of the contributing factors to the inaccurate measurement is the vibration from the environment to the measurement system. The stationary LiDAR optical system allows an easy integration of a suspension damper to isolate the optical bench from external vibrational disturbances. For an automotive grade LiDAR, the TOF measurement should show distance accuracy/precision of 2 cm+/−1 cm and reflectivity accuracy/precision of 10%+/−5%, while the LiDAR is subjected to a constant external vibration. In order to accomplish that, it is important that the LiDAR optical system is vibration free during the distance measurement. The VCSEL illumination source and SPAD of the optical system are mounted on a stationary bench. The integration of spring loaded screws and a damper ring at the bottom portion of the housing can prevent vibration from transmitting to the TOF system. The overall suspension damper hardware is designed to be compact and cost-effective to the overall LiDAR system.

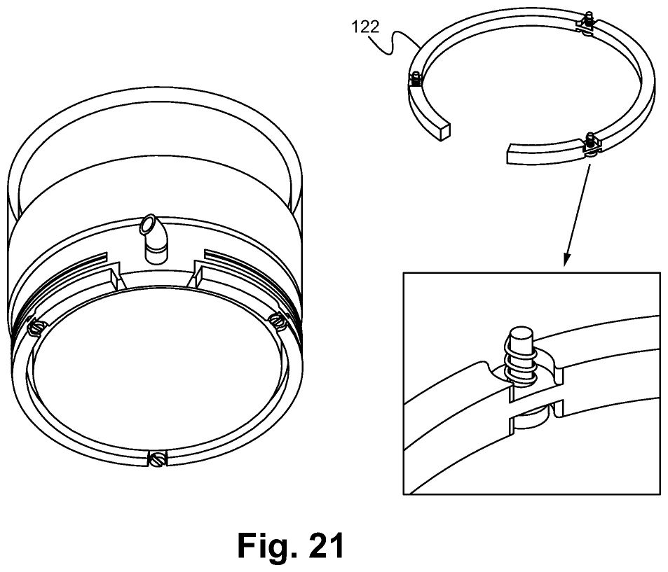

FIG. 21 illustrates a diagram of a damper ring with springs and screws according to some embodiments. In order to prevent the vibration (e.g., from a vehicle) from transmitting to the LiDAR system, spring-loaded screws and a damper ring are attached to the bottom of the LiDAR housing. Although one damper ring is described, the LiDAR system can accommodate more than one damper ring, such as 2, 3, 4, or more. In some embodiments, there are three spring-loaded screws along the circumference of the damper ring. The damper ring has three slotted cut out sections for the screws such that the base of the screw is flush with the damper ring. The springs are mounted on the front side of the screws and fastened to the base of the housing. Similarly, there can be other vibration absorbing dampers in the place of springs such as gel pad or rubber-like materials.

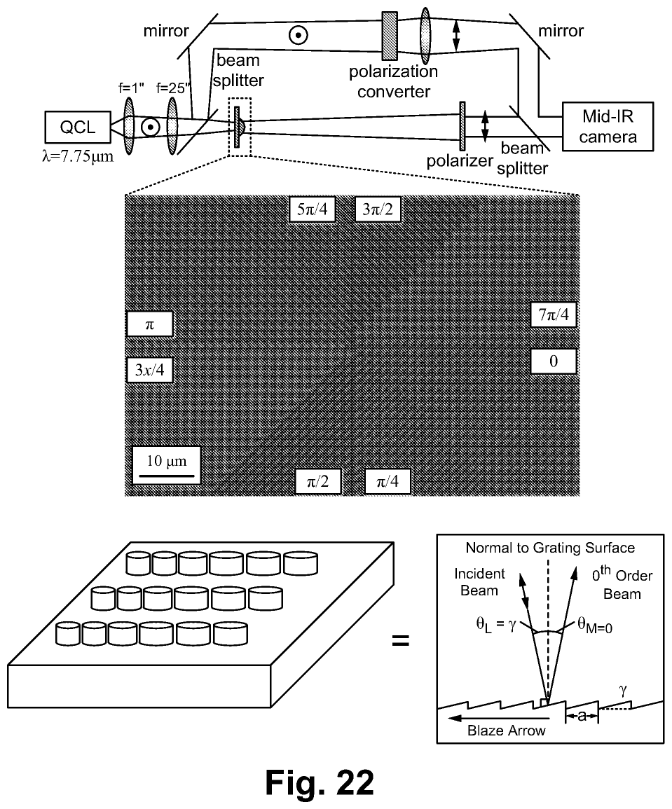

FIG. 22 illustrates a diagram of a metasurface/flat optics implementation according to some embodiments. The flat optics include dielectric pillars of different sizes on a transparent substrate. More specifically, the flat optics include an array of subwavelength pillars with unique features including generating an artificial birefringence and behaving as a waveplate and changing the polarization angle of the incidence light. The flat optics include a periodic structure of n number of dielectric antenna where each element is incremented by (n*π/N) phase where n=1 to N, N elements go from 0 to π and form a blaze grating with an angle of θ.

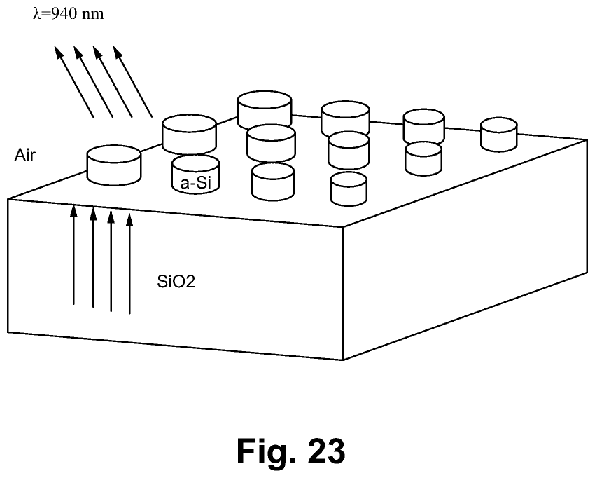

FIG. 23 illustrates a diagram of a meta-atom deflection configuration according to some embodiments. The meta-atom deflection configuration (also referred to as the metasurface/flat optics and used as the deflecting optics/optical lens 106 in FIG. 1) includes a transparent substrate with multiple pillars on top of the transparent substrate configured for directing light. In some embodiments, the transparent substrate is SiO₂, and the pillars are amorphous silicon. The pillars are able to be the different sizes (e.g., different heights and/or different diameters).

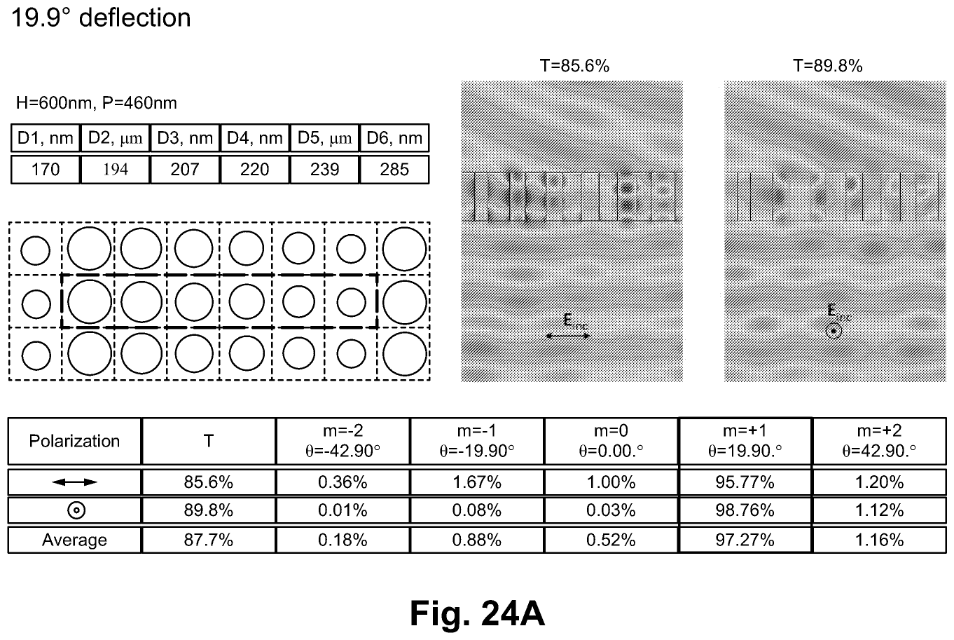

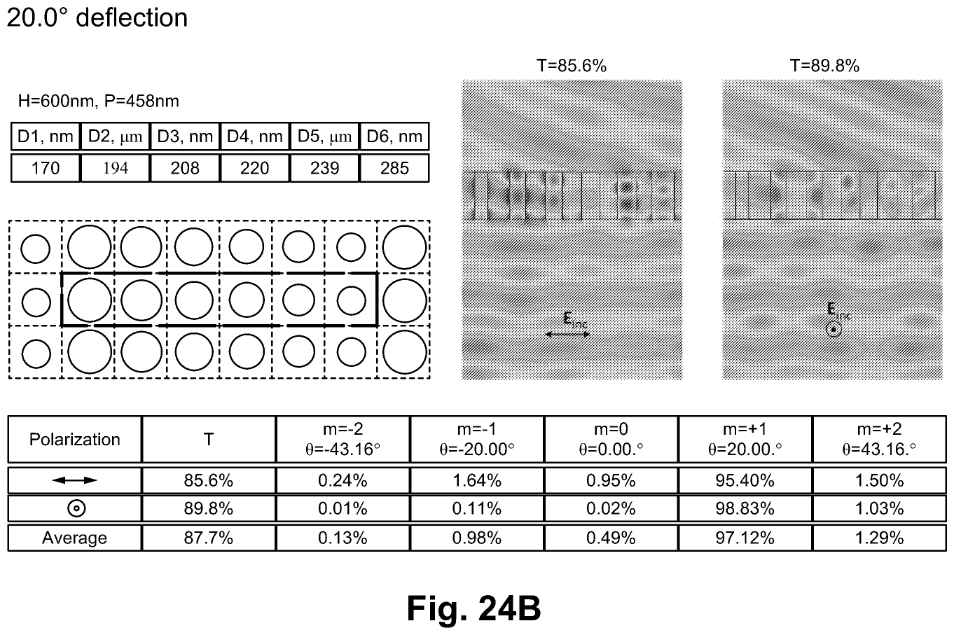

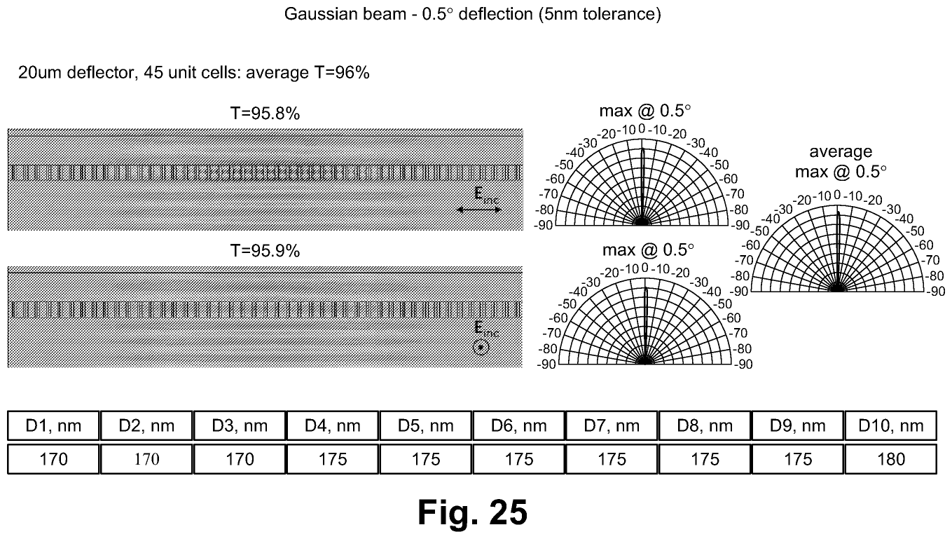

FIGS. 24A-B illustrate diagrams and analysis of deflection by an aperiodic meta-atoms structure according to some embodiments. As shown the meta-atoms structure includes pillars of various diameters. The Figure shows the differences of 19.9° deflection and 20.0° deflection. For example, the first set of pillars deflects the light by 19.9°, and the second set of pillars deflects the light by 20.0°. FIG. 25 illustrates a diagram of a deflector metasurface at 0.5 degrees according to some embodiments. The deflector metasurface is designed by changing the diameters of the pillars and the combination of the diameters of the pillars (e.g., in a set of 10 pillars). Depending on the combination of the pillars, the light is deflected at a different angle.

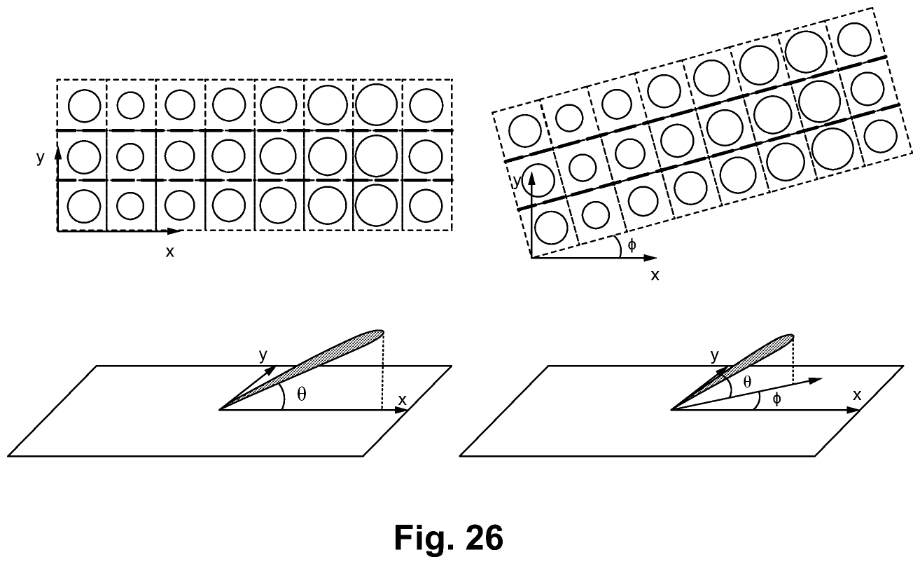

FIG. 26 illustrates diagrams of vertical and horizontal deflector metasurfaces according to some embodiments. The vertical elevation is θ, and the in-plane motion is φ. The deflector metasurface and different configurations of the deflector meta surface are able to affect the vertical elevation and the in-plane motion.

FIG. 27 illustrates the change in vertical elevation of an 8×8 emitter array as a function of azimuthal angle rotation according to some embodiments. The vertical axis represents the vertical elevation angle spread, and the horizontal axis represents the azimuthal angle scan. Points coverage is a function of FOV (vertical and horizontal). Since the LiDAR optical system described herein has variable vertical elevations across HFOV, there is a more dense point cloud center at 180° with a with of +90° and a less dense point cloud towards higher elevation angles.

FIG. 28 illustrates a diagram of a coaxial configuration according to some embodiments. As described herein, in a coaxial configuration, the emission and detection optics are shared, and there is no minimal detectable distance. By using a beam splitter, although the transmitter (e.g., emitter array) and receiver (e.g., detection array) are not positioned in the same physical space, they share the same optical path. For example, the transmitter and the receiver are positioned at a 90 degree angle to each other, but by using the beam splitter, they share the same optical path. This avoids any blind spot.

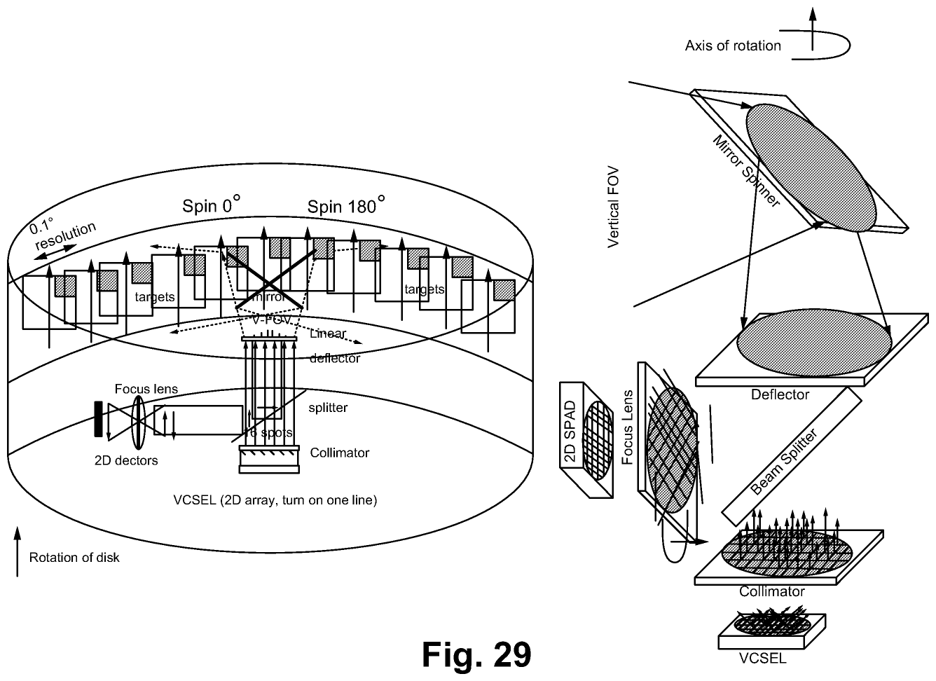

FIG. 29 illustrates the periscope mirror rotating in conjunction with the deflector/metasurface optics according to some embodiments. In some embodiments, the periscope mirror and the deflector (deflection lens) rotate together (e.g., by incorporating the deflector as part of the rotating mechanism with the periscope mirror), unlike the design in FIG. 8 where only the periscope mirror rotates.

To utilize the LiDAR optical system described herein, a device such as a vehicle, or more specifically, an autonomous vehicle, is able to be equipped with the LiDAR optical system to perform a mapping of the surroundings. Based on the mapping, the vehicle is able to perform functions such as avoiding obstacles or alerting a driver. The LiDAR optical system is able to be positioned anywhere on the vehicle such as on the top, front, rear or sides. The LiDAR optical system is able to communicate with the vehicle in any manner such as by wired or wirelessly sending signals to a computing system of the vehicle which is able to take the LiDAR information and perform actions such as stopping the vehicle, changing lanes, and/or triggering an alert in the vehicle.

In operation, the LiDAR optical system is capable of delivering light to a target and detecting a fraction of the light reflected from the target to determine the distance from the light source/detector to the target placed at any point of a 360-degree panoramic field of view across various vertical elevation angles depending on the azimuthal angles. The LiDAR optical system allows the built-in array laser light source and an array of detectors to be scanned across the entire azimuthal angular range. The LiDAR optical system has the unique arrangement of the array of laser light sources, and the array of detectors affixed to a rigid base while the rotating periscope scanner contains a motor and mirror which can rotate in-plane to project the light source to its surroundings and receive light from surroundings. The LiDAR optical system can deliver a high frame rate, a high spatial resolution, and a low power consumption system.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus comprising:
a laser emitting source configured for emitting a laser beam;
one or more optical lens elements configured for collimating the laser beam from the laser emitting source;
a reflecting mirror on an axial field motor;
a light detection array configured for receiving a returned laser beam;
one or more optical focusing lens elements configured for focusing the returned laser beam to the light detection array; and
an optical beam splitter configured for enabling a path of the laser beam from the laser emitting source to the reflecting mirror out to a target and the returned laser beam reflected from the target back to the light detection array.

2. The apparatus of claim 1 wherein the laser emitting source comprises a vertical cavity surface emitting laser array.

3. The apparatus of claim 2 wherein each light emitting source within the laser emitting source is individually selected.

4. The apparatus of claim 2 wherein an optical microlens element to steer a laser beamlet to a specific vertical elevation is on the laser emitting source, and multiple beamlets from the laser emitting source together with the microlens element are arranged uniquely to cover a specific range of vertical elevation angles.

5. The apparatus of claim 4 wherein the one or more optical lens elements is a discrete lens element of certain focal length to reduce divergence of the laser beam from each emitter.

6. The apparatus of claim 1 wherein the light detection array comprises a single photon avalanche detector array.

7. The apparatus of claim 6 wherein the single photon avalanche detector array comprises multiple avalanche photo diode elements to be individually selected and are aligned to receive incoming reflected light corresponding to a particular illuminated portion of the target by the light emitting source of a specific vertical elevation.

8. The apparatus of claim 1 wherein the laser emitting source is a fixed-mount emitter, and the reflecting mirror is configured to rotate to cover entire 360 azimuthal angles.

9. The apparatus of claim 1 further comprising a plurality of Risley Prisms configured to reorient the laser beam before the laser beam goes to the reflecting mirror.

10. The apparatus of claim 9 wherein the plurality of Risley Prisms comprise two wedge lens elements that rotate at a predefined rotational speed.

11. The apparatus of claim 1 further comprising a metasurface flat optics lens configured to reorient the laser beam before the laser beam goes to the reflecting mirror.

12. The apparatus of claim 11 wherein the metasurface flat optics lens comprises a plurality of geometric thin-film lens elements that are deposited on a transparent substrate.

13. The apparatus of claim 1 further comprising a set of electronic components configured to coordinate the sequence of triggering and switching to synchronize the laser firing and returned light to the light detection array for range determination.

14. The apparatus of claim 13 wherein the set of electronic components is configured for controlling the motor rotation and synchronizing the motor, the laser emitting source firing and detection of the returned light, wherein a digital trigger activates a laser driver to fire the laser beam and at the same time turns on a detector window to detect the return light from the target.

15. The apparatus of claim 14 wherein an amplitude of an analog return signal signifies reflectance of the target which is then converted to digital counts and a field programmable gate array processes the digital counts to report reflectivity of the target, wherein from the time for the light to traverse from the laser emitter to the target and back, a time counter reports the time elapsed value to the field programmable gate array, wherein for a targeted point in space, there is the spatial coordinate of the point, the time to travel to the target and back, and the reflectivity of the target, an a 3D point cloud is formed by aggregating all the points and representing the points in a 3D format.

16. The apparatus of claim 1 further comprising a cooling system, a vibration reduction system, and a moisture/humidity mitigation system.

17. The apparatus of claim 1 wherein the laser emitting source and the light detection array are positioned at a 90 degree angle to each other and share a same optical path by utilizing the optical beam splitter.

18. The apparatus of claim 1 wherein the reflecting mirror is configured to spin at a speed to provide a frame rate of 60 Hz or higher, and a resolution of a 3D point cloud acquired is 640×480 pixels or higher.

19. The apparatus of claim 11 wherein the metasurface flat optics lens is configured to rotate in conjunction with the reflecting mirror.

20. The apparatus of claim 1 wherein a variable image resolution in vertical and horizontal directions is generated including a first set of resolution at low elevation angles and a second set of resolution at higher elevation angles.

21. The apparatus of claim 1 wherein a firing duty cycle of the laser emitting source is modified to increase the firing frequency or decrease the firing frequency of the laser emitting source.

22. A system comprising:
a vehicle; and
a Light Detection and Ranging (LiDAR) optical device coupled to the vehicle, the LiDAR optical device comprising:
a laser emitting source configured for emitting a laser beam;
one or more optical lens elements configured for collimating the laser beam from the laser emitting source;
a reflecting mirror on an axial field motor;
a light detection array configured for receiving a returned laser beam;
one or more optical focusing lens elements configured for focusing the returned laser beam to the light detection array; and
an optical beam splitter configured for enabling a path of the laser beam from the laser emitting source to the reflecting mirror out to a target and the returned laser beam reflected from the target back to the light detection array.

23. The system of claim 22 wherein the laser emitting source comprises a vertical cavity surface emitting laser array.

24. The system of claim 23 wherein each light emitting source within the laser emitting source is individually selected.

25. The system of claim 23 wherein an optical microlens element to steer a laser beamlet to a specific vertical elevation is on the laser emitting source, and multiple beamlets from the laser emitting source together with the microlens element are arranged uniquely to cover a specific range of vertical elevation angles.

26. The system of claim 25 wherein the one or more optical lens elements is a discrete lens element of certain focal length to reduce divergence of the laser beam from each emitter.

27. The system of claim 22 wherein the light detection array comprises a single photon avalanche detector array.

28. The system of claim 27 wherein the single photon avalanche detector array comprises multiple avalanche photo diode elements to be individually selected and are aligned to receive incoming reflected light corresponding to a particular illuminated portion of the target by the light emitting source of a specific vertical elevation.

29. The system of claim 22 wherein the laser emitting source is a fixed-mount emitter, and the reflecting mirror is configured to rotate to cover entire 360 azimuthal angles.

30. The system of claim 22 further comprising a plurality of Risley Prisms configured to reorient the laser beam before the laser beam goes to the reflecting mirror.

31. The system of claim 30 wherein the plurality of Risley Prisms comprise two wedge lens elements that rotate at a predefined rotational speed.

32. The system of claim 22 further comprising a metasurface flat optics lens configured to reorient the laser beam before the laser beam goes to the reflecting mirror.

33. The system of claim 32 wherein the metasurface flat optics lens comprises a plurality of geometric thin-film lens elements that are deposited on a transparent substrate.

34. The system of claim 22 further comprising a set of electronic components configured to coordinate the sequence of triggering and switching to synchronize the laser firing and returned light to the light detection array for range determination.

35. The system of claim 34 wherein the set of electronic components is configured for controlling the motor rotation and synchronizing the motor, the laser emitting source firing and detection of the returned light, wherein a digital trigger activates a laser driver to fire the laser beam and at the same time turns on a detector window to detect the return light from the target.

36. The system of claim 35 wherein an amplitude of an analog return signal signifies reflectance of the target which is then converted to digital counts and a field programmable gate array processes the digital counts to report reflectivity of the target, wherein from the time for the light to traverse from the laser emitter to the target and back, a time counter reports the time elapsed value to the field programmable gate array, wherein for a targeted point in space, there is the spatial coordinate of the point, the time to travel to the target and back, and the reflectivity of the target, an a 3D point cloud is formed by aggregating all the points and representing the points in a 3D format.

37. The system of claim 22 further comprising a cooling system, a vibration reduction system, and a moisture/humidity mitigation system.

38. The system of claim 22 wherein the laser emitting source and the light detection array are positioned at a 90 degree angle to each other and share a same optical path by utilizing the optical beam splitter.

39. The system of claim 22 wherein the reflecting mirror is configured to spin at a speed to provide a frame rate of 60 Hz or higher, and a resolution of a 3D point cloud acquired is 640×480 pixels or higher.

40. The system of claim 32 wherein the metasurface flat optics lens is configured to rotate in conjunction with the reflecting mirror.

41. The system of claim 22 wherein a variable image resolution in vertical and horizontal directions is generated including a first set of resolution at low elevation angles and a second set of resolution at higher elevation angles.

42. The system of claim 22 wherein a firing duty cycle of the laser emitting source is modified to increase the firing frequency or decrease the firing frequency of the laser emitting source.

43. A method programmed in a non-transitory of a device comprising:
emitting a laser beam from a laser emitting source;
collimating the laser beam from the laser emitting source with one or more optical lens elements;
receiving a returned laser beam with a light detection array;
focusing the returned laser beam to the light detection array with one or more optical focusing lens elements; and
enabling, with an optical beam splitter, a path of the laser beam from the laser emitting source to a reflecting mirror on an axial field motor out to a target and the returned laser beam reflected from the target back to the light detection array.

44. The method of claim 43 wherein the laser emitting source comprises a vertical cavity surface emitting laser array.

45. The method of claim 44 wherein each light emitting source within the laser emitting source is individually selected.

46. The method of claim 44 wherein an optical microlens element to steer a laser beamlet to a specific vertical elevation is on the laser emitting source, and multiple beamlets from the laser emitting source together with the microlens element are arranged uniquely to cover a specific range of vertical elevation angles.

47. The method of claim 46 wherein the one or more optical lens elements is a discrete lens element of certain focal length to reduce divergence of the laser beam from each emitter.

48. The method of claim 43 wherein the light detection array comprises a single photon avalanche detector array.

49. The method of claim 48 wherein the single photon avalanche detector array comprises multiple avalanche photo diode elements to be individually selected and are aligned to receive incoming reflected light corresponding to a particular illuminated portion of the target by the light emitting source of a specific vertical elevation.

50. The method of claim 43 wherein the laser emitting source is a fixed-mount emitter, and the reflecting mirror is configured to rotate to cover entire 360 azimuthal angles.

51. The method of claim 43 further comprising reorienting the laser beam before the laser beam goes to the reflecting mirror with a plurality of Risley Prisms.

52. The method of claim 51 wherein the plurality of Risley Prisms comprise two wedge lens elements that rotate at a predefined rotational speed.

53. The method of claim 43 further comprising reorienting the laser beam before the laser beam goes to the reflecting mirror with a metasurface flat optics lens.

54. The method of claim 53 wherein the metasurface flat optics lens comprises a plurality of geometric thin-film lens elements that are deposited on a transparent substrate.

55. The method of claim 43 further comprising coordinating the sequence of triggering and switching to synchronize the laser firing and returned light to the light detection array for range determination with a set of electronic components.

56. The method of claim 55 wherein the set of electronic components is configured for controlling the motor rotation and synchronizing the motor, the laser emitting source firing and detection of the returned light, wherein a digital trigger activates a laser driver to fire the laser beam and at the same time turns on a detector window to detect the return light from the target.

57. The method of claim 56 wherein an amplitude of an analog return signal signifies reflectance of the target which is then converted to digital counts and a field programmable gate array processes the digital counts to report reflectivity of the target, wherein from the time for the light to traverse from the laser emitter to the target and back, a time counter reports the time elapsed value to the field programmable gate array, wherein for a targeted point in space, there is the spatial coordinate of the point, the time to travel to the target and back, and the reflectivity of the target, an a 3D point cloud is formed by aggregating all the points and representing the points in a 3D format.

58. The method of claim 43 wherein the laser emitting source and the light detection array are positioned at a 90 degree angle to each other and share a same optical path by utilizing the optical beam splitter.

59. The method of claim 43 wherein the reflecting mirror is configured to spin at a speed to provide a frame rate of 60 Hz or higher, and a resolution of a 3D point cloud acquired is 640×480 pixels or higher.

60. The method of claim 53 wherein the metasurface flat optics lens is configured to rotate in conjunction with the reflecting mirror.

61. The method of claim 43 generating a variable image resolution in vertical and horizontal directions including a first set of resolution at low elevation angles and a second set of resolution at higher elevation angles.

62. The method of claim 43 further comprising modifying a firing duty cycle of the laser emitting source to increase the firing frequency or decrease the firing frequency of the laser emitting source.
